(19) United States
(12) Patent Application Publication
(10) Pub. No.: US 2026/0228336 A1
(43) Pub. Date: Aug. 6, 2026

(54) DUPLICATE FILE SCANNING AND RESTORE DURING A NETWORK DATA MANAGEMENT PROTOCOL PROCESS

(71) Applicant: Dell Products L.P., Round Rock, TX (US)

(72) Inventor: Avadut Mungre, Bicholim (IN)

(21) Appl. No.: 19/043,881

(22) Filed: Feb. 3, 2025

(51) Int. Cl. G06F 21/56; G06F 11/14

(52) U.S. Cl. CPC G06F 21/568; G06F 11/1464; G06F 21/565

(57) ABSTRACT

The described technology is generally directed towards automatic virus scanning of a file while restoring the file. Virus scanning of a duplicate file of the file to be restored can be concurrently performed while the unavailable file is undergoing restoration. The unavailable file and the duplicate file can be located on one or more nodes of a node cluster forming a distributed file system. Upon determining that a first file is unavailable (e.g., as part of a file read operation), a second, duplicate copy can be identified based upon a common fingerprint of the first file and the second file. The first file can undergo restoration using a third file (backup copy of the first file) to generate a fourth, restored file. Hence, with the virus scan performed, the restored file can be immediately provided to a client.

### BACKGROUND

Data replication is a process for creating and storing multiple copies of data in different locations, e.g., as part of a data protection/disaster recovery process. A data storage system (e.g., a network attached storage (NAS) system) conventionally utilizes external anti-virus servers in order to prevent virus infected files entering or residing in the data storage system.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

In one or more embodiments described herein, systems, devices, computer-implemented methods, configurations, apparatus, and/or computer program products are presented to concurrently perform a software virus check on restored data during the data restoration process.

According to one or more embodiments, a digital data storage system is presented, wherein the digital data storage system comprises at least one processor, and at least one memory coupled to the at least one processor and having instructions stored thereon, wherein the digital data storage system can be configured to automatically initiate/control restoration of a file in conjunction with virus scanning of the file. In response to the at least one processor executing the instructions, the instructions facilitate performance of operations, comprising receiving a command to perform an operation on a first file, and further, in response to determining that the first file is unavailable, identifying a second file, wherein second file is a duplicate of the first file. In an embodiment, the operations can further comprise performing a virus scan on the second file to determine whether the second file comprises any software virus. In another embodiment, the operations can further comprise, in response to the second file being determined not to comprise a software virus, identifying the first file as being virus free.

In another embodiment, the first file can be distributed across first storage equipment of a distributed file system and the second file can be distributed across second storage equipment of the distributed file system.

In a further embodiment, the operations can further comprise restoring the first file, resulting in a restored first file. The operations can further comprise, in response to the first file being determined to be virus free, serving the restored first file to a client system, wherein the command to perform the operation on the first file is received from the client system.

In another embodiment, the operations can further comprise restoring the first file with a third file to generate a fourth file, wherein the fourth file is a restored version of the first file.

In a further embodiment, the third file can be a backup file of the first file.

In another embodiment, the first file can be located at a first data storage system and the third file can be located at a second data storage system, and wherein the second data storage is remotely located from the first data storage system.

In a further embodiment, the first file can be located on a first node in the first data storage system, and the second data storage system can be a tape backup system.

In another embodiment, the operations can further comprise generating a first fingerprint of the first file, and further comparing the first fingerprint with a second fingerprint generated for the second file. In a further embodiment, the operations can further comprise, in response to determining that the first fingerprint matches the second fingerprint, determining that the second file is the duplicate of the first file.

In an embodiment, the first fingerprint and the second fingerprint are generated using a hashing process.

In a further embodiment, the command to perform the operation can be a first command to perform a read file operation or a second command to perform an open file operation.

In further embodiments, a computer-implemented method is provided, wherein the method comprises in response to a file instruction received from a client system remotely located from a digital storage system comprising a first file and a second file, determining, by a device comprising at least one processor, that the first file is unavailable. In an embodiment, the method can further comprise comparing, by the device, a first digital fingerprint generated from the first file with a second digital fingerprint generated from the second file, and further, in response to the first fingerprint and the second fingerprint being determined to match, identifying, by the device, the second file to be a duplicate of the first file. In a further embodiment, the method can further comprise, based on the identifying of the second file to be the duplicate of the first file, performing, by the device, a virus scan on the second file to confirm whether the first file comprises a computer virus.

In an embodiment, the file instruction can comprise one of a first instruction to perform a read file operation for the first file or a second instruction to perform an open file operation for the first file.

In a further embodiment, the method can further comprise restoring, by the device, the first file to generate a restored version of the first file, and further, in response to a result of the performing of the virus scan indicating that the second file does not comprise any computer virus, executing, by the device, the file instruction on the restored version of the first file.

In another embodiment, the first file can be restored with a third file, wherein the third file is a backup copy of the first file, and wherein the third file is located on a backup data server remotely located from the digital storage system.

In an embodiment, the digital storage system can be a network attached storage system.

In another embodiment, the digital storage system can be a distributed file system comprising a cluster of two or more data storage nodes, wherein the first file is located on a first data storage node in the distributed file system and the second file is located on a second data storage node in the distributed file system, and wherein the first data storage node and the second data storage node are disparate.

Further embodiments can include a computer program product stored on a non-transitory computer-readable medium and comprising machine-executable instructions, wherein in response to being executed, the machine-executable instructions cause a system to perform operations, comprising comparing a first digital fingerprint with a second digital fingerprint, wherein the first digital fingerprint is obtained from a first file located in a distributed file system, wherein the first file is undergoing a file restoration process, wherein the second digital fingerprint is generated from a second file, and wherein the second file is located in the distributed file system. In an embodiment, the operations can further comprise, in response to determining the second digital fingerprint matches the first digital fingerprint, performing a virus scan operation on the second file to determine whether the second file comprises a software virus. In a further embodiment, the operations can further comprise in response to the second file being determined not to comprise any software virus, identifying the first file as being free of any software virus.

In an embodiment, the first file is identified in a file operation command received at the distributed file system, wherein the file operation command is one of a read file operation command for the first file or an open file operation command for the first file, and wherein the file operation command is received from a client system remotely located from the distributed file system.

In an embodiment, the first digital fingerprint and the second digital fingerprint are generated by a common hashing process.

In another embodiment, the operations can further comprise restoring the first file to create a third file, wherein the third file is a restored version of the first file, and wherein the third file is generated using a network data management protocol restoration process. In a further embodiment, the operations can further comprise, in response to identifying the first file as being free of any software virus, enabling the third file to be accessible to a client system, wherein the client system is remotely located from the distributed file system.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIGS. 1A-1B present example schematics of a system configured to automatically implement a virus scan during implementation of a data restore process, in accordance with one or more embodiments.

FIG. 2 presents an example fingerprint lookup table utilized as part of a virus scan and file restore process, in accordance with one or more embodiments.

FIG. 3 presents an example computer-implemented method for automated and concurrent restoration of a file and virus scanning to confirm the restored file does not contain a virus, in accordance with one or more embodiments.

FIG. 4 presents an example computer-implemented method for automatically generating and storing fingerprints of a file to determine presence of a duplicate file, in accordance with one or more embodiments.

FIG. 5 presents an example computer-implemented method for automated virus scanning concurrent with file restoration, in accordance with one or more embodiments.

FIG. 6 presents an example computer-implemented method for automated virus scanning concurrent with file restoration, in accordance with one or more embodiments.

FIG. 7 presents an example computer-implemented method for automated virus scanning concurrent with file restoration, in accordance with one or more embodiments.

FIG. 8 presents an example environment for implementing various embodiments presented herein.

FIG. 9 illustrates an example wireless communication system, in accordance with one or more embodiments described herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is to be appreciated, however, that the various embodiments can be practiced without these specific details, e.g., without applying to any particular networked environment or standard. In other instances, well-known structures and devices are shown in block diagram form in order to facilitate describing the embodiments in additional detail.

### 1. Overview

As mentioned, data storage systems, such as NAS systems, conventionally utilize external anti-virus servers in order to prevent virus infected files entering or residing in the data storage system. However, in the event of a data file includes a software virus, a data restore operation can be needlessly/erroneously performed on the data file, further extending the time required for the data restore operation, e.g., the data restore operation has to be further performed on subsequently identified data that does not include a virus. Such a data restore operation can lead to an unwanted delay in access of the data, a delay which is further exacerbated by the data restore operation on data potentially comprising a software virus.

In this regard, data replication can involve writing/storing data/computer object(s) at two or more data storage locations/data repositories. A particular issue of concern is the transmission/storage of virus infected files across a data storage system. It is to be appreciated that the term “virus,” as used herein, pertains to any computer code/software (e.g., malware) configured to deleteriously affect operation of a computer, a computer network, a data server, and the like. In an aspect, a software virus can be configured to replicate itself by modifying computer programs and/or computer files by inserting deleterious/undesired software code into one or more computer programs and/or computer files. A computer program and/or computer file that includes a software virus can be said to be “infected.”

Generally, a virus scan can be performed at any of the following situations:
1) a virus scan on real time access, such as:
   a) perform a virus scan in response to receiving a data write/close operation/command. For example, when a user/client writes a new file or modifies an existing file and closes it, a virus scan is triggered for that file.
   b) perform a virus scan on a data read/open operation/command. For example, when a user/client tries to read or open a file, a virus scan is triggered for that file.
2) a scheduled virus scan. For example, virus scanning of a configured path is triggered at a pre-defined time.
3) a forced scan. For example, a data/system administrator can perform a virus scan at any desired time.

The various embodiments presented herein relate to a virus scan being performed when a read/open request is initiated (e.g., step 1b above). In the event of a virus scan on a read/open operation has been enabled (e.g., via a policy), the requested file can be scanned when a file read/open request is initiated.

The various embodiments presented herein minimize the delay involved in scanning a requested file for which a restore is in progress, by utilizing a duplicate copy of the file which already exists on a data storage system. The original client request has already been delayed as a restore operation had to be initiated. Per the various embodiments presented herein, by utilizing a virus scan on the duplicate file concurrent with the file restore, the read delay incurred due to virus-scanning will be minimized as the virus-scan is performed in parallel with the file restore operation.

A conventional data restore operation comprises:
1) a file read operation is requested by a client.
2) a determination is made that the requested file to be read is unavailable (e.g., data unavailable at a local device), and a data restore operation is initiated. In an example scenario, the data restore operation can be a network data management protocol (NDMP) restore operation, however, any suitable restore operation/process can be initiated as applicable for the particular data type, data format, etc., of the unavailable requested file.
3) upon completion of the data restore operation, the file will be successfully restored.
4) the restored file undergoes virus scanning. In an example scenario, the virus scan involves performing the virus scan at the local device. In another example scenario, the virus scan can involve transmitting the restored file to a virus checking device remotely located from the local device.
5) in response to no virus being found in the restored file, the restored file can be served to the client for the read operation to be performed.

Per the foregoing, the file restore operation is initially performed and then the virus check operation is performed. Hence, steps 2 and 3 and steps 4 and 5 are performed sequentially, e.g., the virus check operation is not performed until the file has been restored at the data device.

Further, in a conventional system, the virus scanning operation is performed by an anti-virus system (e.g., an anti-virus server) located externally to the data storage system (e.g., a network attached storage (NAS) system) in order to prevent virus-infected files from entering or residing on the data storage system. For example, in a conventional system comprising a distributed file system (e.g., comprising a cluster of data storage nodes), files stored/accessible on the distributed file system are scanned for viruses/malware by anti-virus servers located external to the distributed file system.

Per the various embodiments presented herein, a file restore and virus check operation can be performed as follows:
1) a file read or file open operation is requested by a client.
2) a determination is made that the requested file to be read is unavailable (e.g., data unavailable at a local device), and a data restore operation (e.g., an NDMP restore operation) is initiated. In an embodiment, the requested file is located on a node in a node cluster. In an embodiment, the node cluster can be a collection of nodes configured to function together to form a distributed file system.
3) a data restore operation of the requested file is initiated and a check operation is performed (e.g., in parallel with the NDMP restore operation) to determine whether a duplicate copy of the unavailable file exists on a node within the node cluster that includes the node on which the unavailable file is located. In an embodiment, the unavailable file and the duplicate file can each be configured with a fingerprint/unique identifier (e.g., a digital fingerprint), whereby the respective fingerprints can be included in a fingerprint lookup table/database, with corresponding files being identified based on matching fingerprints.
4) concurrent with the file restore operation, the duplicate copy can undergo virus checking/scanning.
5) in the event of no virus is found, the restored file can be served/forwarded to the client initiating the file read/open operation, e.g., for the read operation to be performed.
6) in the event of a virus is found, the data restore operation can a) be terminated, or b) the restored file undergoes further virus scanning, per the conventional approach, as previously described.

Hence, per the various embodiments presented herein, the virus check and restore operation can be performed concurrently, with the virus scan status being available prior or upon completion of the file restore operation. Accordingly, by performing the virus scan concurrent with the file restore operation, in the event of the virus scan indicating the duplicate copy includes a software virus, serving of the restored file to the client system can be terminated rather than waiting for the file to be restored and then performing the virus scan. The virus scan returning an indication that the restored file will include a software virus can also terminate the file restore process prior to the time it would take to complete the file restore process.

Hence, with the previously described conventional approach, the data restore operation can take an undesirable duration of time, and further the data restore operation may be erroneously performed as the data restore operation is being performed on data that contains a software virus, which further requires the initial data restore operation to now be terminated with a data restore operation to be subsequently performed on data that is virus free, which can lead to a further extended duration of time. Per the embodiments presented herein, the served file is only provided to the client in the event of no software virus is found in the duplicate file.

As previously mentioned, fingerprints (a.k.a. hashes) of respective files can be generated and compared, whereby a first fingerprint generated from a first file (e.g., the file to be restored) and a second fingerprint generated from a second file (e.g., the duplicate file) can be compared, and in response to determining the first fingerprint and the second fingerprint match, the second file can be considered to be a duplicate of the first file. In an embodiment, a hash process can be applied to the respective files to generate the respective fingerprints. For example, a MD5 hash process can be utilized, whereby, given the MD5 hash process consistently produces the same output (e.g., a 128-bit hash output) for the same given input, a comparison of the first hash of the first file with a second hash of the second file can indicate the first file and the second file comprise the same content, e.g., the second file is an intact, unmodified version of the first file, whereby the data integrity of the first file and the second file are consistent. Any suitable hashing process can be utilized, e.g., MD5 hash generator, SHA-1 hash generator, SHA 256 hash generator, and the like.

### 2. Concurrent Virus Scan System

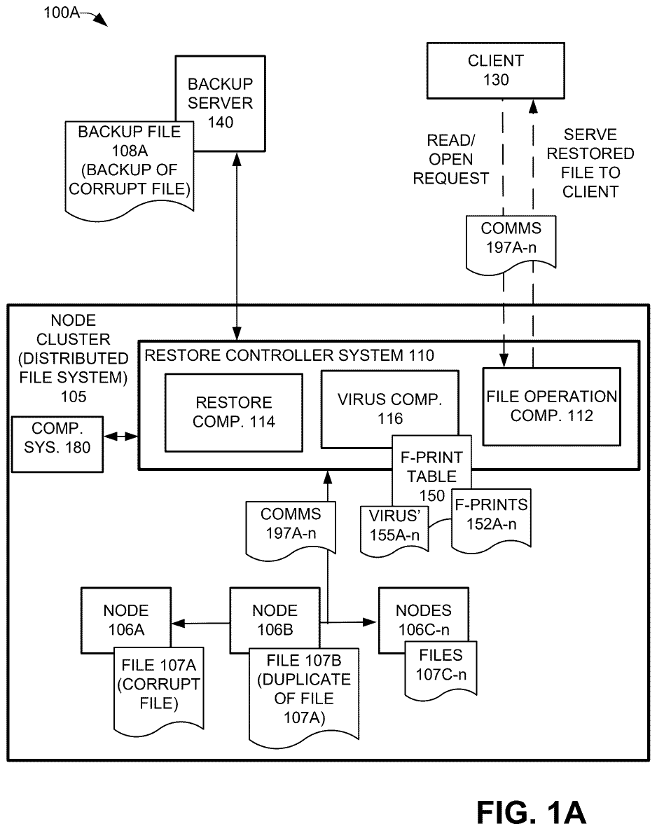

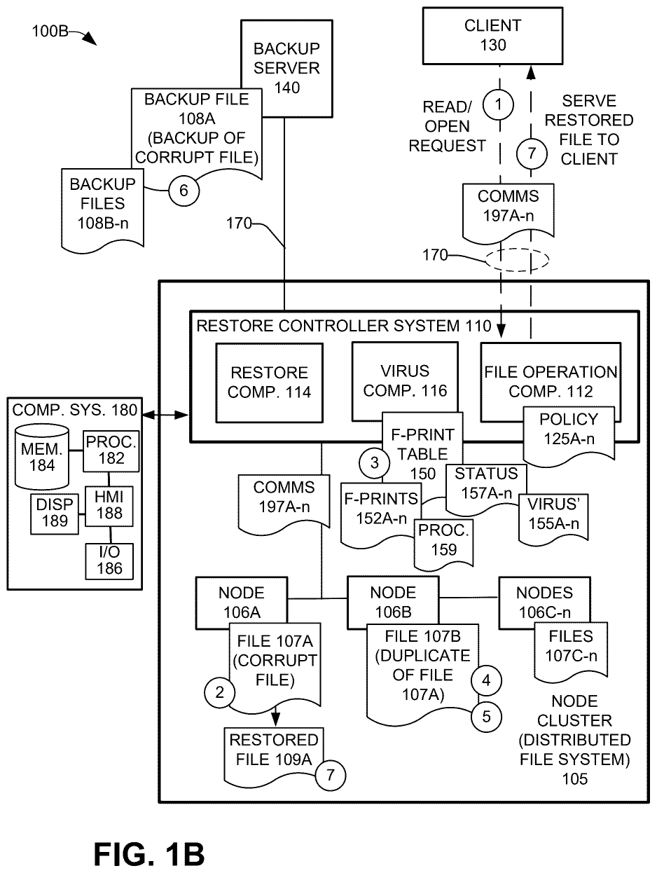

FIGS. 1A-1B present example schematics of a system 100 (presented as systems 100A and 100B) configured to implement a virus scan during implementation of a data restore process, in accordance with one or more embodiments. The term n, as used herein is any positive integer.

As further described, FIG. 1A provides a high-level overview of system 100 regarding the various embodiments presented herein, and FIG. 1B illustrates system 100 during execution of a virus scan concurrent with a data restore operation.

Turning to FIG. 1A, system 100A presents a node cluster configured with a data restore and virus scan functionality. As shown, a node cluster 105 comprises a collection of nodes 106A-n, whereby the node cluster 105 can be considered to be a distributed file system comprising a plurality of data storage devices, a.k.a., nodes.

The node cluster 105 can be communicatively coupled to a client system 130, wherein the client system 130 can be remotely located from the node cluster 105. Further, the node cluster 105 can be communicatively coupled to a backup server 140. The nodes 106A-n and the backup server 140 can comprise any suitable hardware, e.g., disk drives, tape drives, and the like.

In an aspect, node cluster 105 can be considered to be a local storage system (LSS), a.k.a. a primary system, located local to a system (e.g., client system 130) initiating any of a read operation, write operation of a data object (e.g., files 107A-n, as further described). Further, the backup server 140 can be considered to be a remote storage system (RSS), a.k.a. a replica system, with the backup server 140 being located remotely from the node cluster 105 and/or the client system 130 (e.g., where the read/write operation is being initiated). For example, LSS is located onsite while RSS is at a remote site.

In an embodiment, a first file 107A can be located on a first node 106A. Further, a second file 107B can be located on a second node 106B, whereby, as further described, the second file 107B can be a duplicate of the first file 107A. Furthermore, a third file 108A can be located at the backup server 140, whereby the third file 108A is a data backup of the first file 107A (and also of the second file 107B, given that the second file 107B is a duplicate of the first file 107A).

As further shown, a data restore controller system (RCS) 110 can be located at the node cluster 105, wherein RCS 110 can be configured to control operation of the node cluster 105, replication/backup of files 107A-n, etc., in accordance with any suitable protocol, e.g., NDMP protocol.

RCS 110 can include a file operation component 112, whereby the file operation component 112 can be configured to receive instructions/commands (e.g., a file read command, a file open command, etc.) from the client system 130. The file operation component 112 can be further configured to serve the client system 130 with files 107A-n, e.g., in response to a read command received from client system 130.

RCS 110 can further include a restore component 114, whereby the restore component 114 can be configured to determine an integrity of a particular file (e.g., file 107A pertaining to a read request), and in the event of the particular file may be unavailable (e.g., due to failure of node 106A, data corruption of file 107A, and the like), the restore component 114 can be further configured to initiate and implement a restore process on the file of interest (e.g., file 107A). The restore component 114 can be configured to implement restoring of file 107A by utilizing a backup copy, e.g., file 108A, located at the backup server 140.

RCS 110 can further include a virus component 116, whereby the virus component 116 can be configured to perform a virus scan on a duplicate file (e.g., file 107B) of the original file of interest (e.g., file 107A). As further described, the virus component 116 can utilize respective fingerprints 120A-n generated for the respective files 107A-n, whereby virus component 116 can be configured to determine duplicate files (e.g., files 107A and 107B are duplicates) based on matching of respective fingerprints 120A-n (e.g., stored in a look-up table 150). The virus component 116 can be further configured to determine whether an original file 107A includes a software virus based on virus scanning the duplicate file 107B. In the event of determining duplicate file 107B does not include a virus 155A-n, the restored file 109A can be deemed to be virus-free and the restored file 109A can be provided/made accessible to the client system 130.

Various communications 197A-n can be utilized across system 100/RCS 110, between file operation component 112, restore component 114, virus component 116, client 130, backup server 140, nodes 106A-n, etc. Communications 197A-n can include notifications, instructions, status updates, selections, data, files 107A-n and 108A-n, file operations (e.g., file read command, file open command, file close command, file write/edit command, etc.), virus scan information/status' (e.g., virus not found, virus found), and the like.

As further described, any components included in system 100 (e.g., RCS 110, and subcomponents, and such, can include/be communicatively coupled to a computer system 180, comprising at least one processor 182A-n and memory 184A-n. Further, while not shown, client 130 and backup server 140 can also include respective computer systems 180B-n.

Turning to FIG. 1B, system 100B, presents a node cluster configured with a data restore and virus scan functionality. To aid understanding of the various embodiments presented herein, various operation are presented as a sequence of steps.

Step 1: file operation component 112 can be configured to receive a command/instruction to access/perform an operation on a file, e.g., file 107A, whereby the command can be received from a client system 130. The command can be a read/open instruction directed at the file 107A.

Step 2: file operation component 112 can be configured to determine the requested file 107A is located on node 106A of the node cluster 105. File operation component 112 can be further configured to identify the requested file 107A is unavailable and has to undergo a file restoration process. In response to determining file 107A is implicated to undergo a file restoration process, file operation component 112 can be configured (e.g., via an operation policy 125A implemented at file operation component 112) to initiate operation of the restore component 114 to perform the file restoration process. In further response to determining file 107A is implicated to undergo a file restoration process, file operation component 112 can be configured (e.g., via operation policy 125A) to initiate operation of the virus component 116 to perform a virus scan operation pertaining to file 107A, wherein the virus scan operation can be performed by the virus component 116 concurrent with the file restoration process performed by the restore component 114.

Step 3: virus component 116 can be configured to refer to a fingerprint lookup table 150 comprising respective fingerprints 152A-n of respective files 107A-n stored across the nodes 106A-n.

Step 4: in response to virus component 116 determining/identifying a fingerprint match between a first fingerprint 152A (created for file 107A) and a second fingerprint 152B (created for file 107B), virus component 116 can be configured to determine/identify that second file 107B is a duplicate of the first file 107A. In the example presented in FIG. 1B, file 107A is located on node 106A and file 107B is located on node 106B.

Step 5: virus component 116 can be further configured to perform a virus scan on the duplicate file, file 107B. As shown in FIG. 1B, a plurality of known software viruses 155A-n can be available to the virus component 116 for the virus component 116 to compare content of duplicate file 107B with the one or more known software viruses 155A-n. In an example embodiment, in response to virus component 116 determining that duplicate file 107B does not include a virus 155A-n, virus component 116 can be configured to identify/flag duplicate file 107B as being virus free (e.g., per a virus status 157A), and accordingly, file 107A can be considered to be virus free.

Step 6: as previously mentioned, restore component 114 can be configured to restore corrupt file 107A with a backup file 108A of file 107A to create restored file 109A. As part of the restore process, restore component 114 can be configured to previously save the backup file 108A to the backup server 140.

Step 7: upon restoration of file 107A (with backup file 108A creating restored file 109A) and confirmation of file 107B does not include a virus 155A-n (e.g., virus status 157A =NO), file operation component 112 can be configured to provide the restored version file 109A of file 107A to the requesting client 130.

Per the foregoing steps 1-7 presented in FIG. 1B, steps 3-5 (virus scan operation) and step 6 (file restore operation) are performed concurrently. As previously mentioned, concurrent performance of file restoration and a virus scan is distinct/different from a conventional approach that a) restores the file and then subsequently b) performs the virus scan operation on the restored file.

Returning to FIG. 1B, step 5, as mentioned, in the event of the duplicate file 107B being determined to be virus free (e.g., virus status 157A=NO), policy 125A can be configured to enable serving of restored file 109A to client 130. Further, in the event of virus component 116 determines that duplicate file 107B includes a software virus 155A (e.g., virus status 157A=YES), policy 125A can be configured such that operations return to a conventional approach, whereby restore component 114 is configured to generate restored file 109A and virus component 116 subsequently performs a virus check on the restored file 109A. Similarly, in the event of virus component 116 does not find a matching fingerprint 152B-n for file 107A, policy 125A can be configured such that operations return to a conventional approach, whereby restore component 114 is configured to generate restored file 109A and virus component 116 subsequently performs a virus check on the restored file 109A.

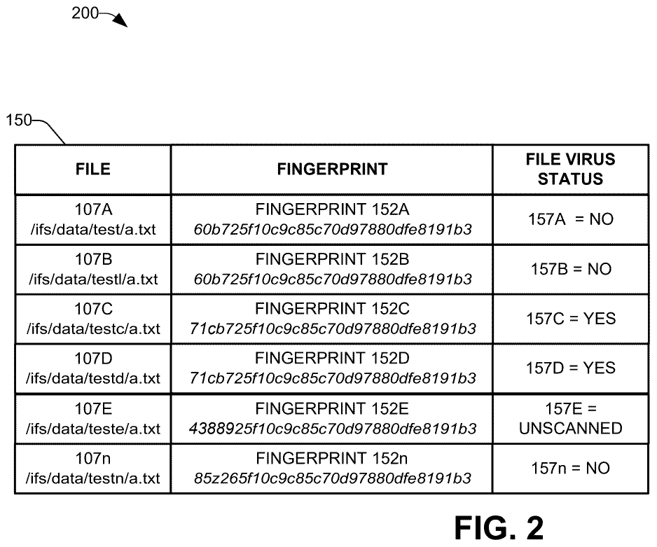

As further described, with reference to FIG. 2, based on the virus status determination of a file 107A-n by virus component 116, virus component 116 can be configured to update the respective files 107A-n with a respective file virus status 157A-n. For example, as shown in FIG. 2, with file 107B being determined to be virus free, virus component 116 can be configured to apply a file virus status 157B with NO to file 107B, and similarly a file virus status 157A of NO to file 107A. Alternatively, in the event of virus component 116 identifies a file 107C to include a virus 155A, virus component 116 can be configured to apply a file virus status 157C with YES to file 107C. File 107D is a duplicate of file 107C, and accordingly, virus component 116 can be configured to apply a file virus status 157D with YES to file 107D. File 107E has yet to be involved in a virus scan operation by virus component 116, with virus component 116 being configured to apply a file virus status 157E of UNSCANNED. File 107n can be associated with a prior virus scanning operation, and with no virus found, virus component 116 can be configured to apply a file virus status 157n with NO to file 107n.

As shown in FIG. 1B, any of the components (e.g., RCS 110, file operation component 112, restore component 114, virus component 116), file storage systems (e.g., node cluster 105, nodes 106A-n, servers 140A-n), etc., can be communicatively coupled to a computer system 180. The computer system 180 can comprise a processor 182 and a memory 184, wherein the processor 182 can execute the various computer-executable components, functions, operations, etc., presented herein, e.g., any of components in RCS 110, file operation component 112, restore component 114, virus component 116, and such. The memory 184 can be utilized to store the various computer-executable components, functions, code, etc., as well as information regarding any of files 107A-n, 108A-n, 109A-n, file virus status 157A-n, fingerprint lookup table 150, fingerprints 152A-n, known viruses 155A-n, operational state of nodes 106A-n, and suchlike.

As further shown, computer system 180 can include an input/output (I/O) component 186, wherein the I/O component 186 can be a transceiver configured to enable transmission/receipt of information, files, and data between any of the components included in system 100 (e.g., between distributed file system 105, client 130, and/or backup server 140). I/O component 186 can be communicatively coupled to the remotely located devices and systems, e.g., client systems 130A-n configured to access/receive files 107A-n (e.g., download file, read file, write file, and such) at node cluster 105, storing and receipt of backup files 108A-n at backup server 140, etc. In an embodiment, I/O component 186 can be configured to transmit various communications 197A-n regarding files 107A-n, backup files 108A-n, restored files 109A-n, e.g., regarding access/availability of the files 107A-n, virus status 157A-n of files 107A-n, etc.

In an embodiment, the computer system 180 can further include a human-machine interface (HMI) 188 (e.g., a display, a graphical-user interface (GUI)) which can be configured to present various information including any of files 107A-n, backup files 108A, restored files 109A-n, fingerprint table 150, fingerprints 152A-n, viruses 155A-n, policy 125A-n, communications 197A-n, operation of nodes 106A-n, file virus status 157A-n, etc., per the various embodiments presented herein. The HMI 188 can include an interactive display 189 to present the various information via various screens presented thereon, and further configured to facilitate input of policies 125A-n, known viruses 155A-n, configuration of fingerprint table 150, and configurations, information/settings/etc., files 107A-n, backup files 108A-n, restored files 109A-n, etc.

Distributed file system 105, RCS 110, backup server 140, and/or client 130 can be communicatively coupled via any suitable technology/system, such as a network (e.g., a LAN) 170, cloud computing technologies, etc.

FIG. 2, table 200 illustrates a fingerprint table utilized as part of a virus scan and file restore process, in accordance with an embodiment. As shown, files 107A and 107B have the same hash value (e.g., 60b725f10c9c85c70d97880dfe8191b3) in conjunction with file virus status' 157A and 157B of NO. As shown, files 107C and 107D have the same hash value (e.g., 71cb725f10c9c85c70d97880dfe8191b3) in conjunction with file virus status' 157C and 157D of YES. File 107E (hash value of 4388925f10c9c85c70d97880dfe8191b3) is unscanned, with a file virus status 157E of UNSCANNED. File 107n (hash value of 85z265f10c9c85c70d97880dfe8191b3) has a file virus status 157n of NO.

### 3. Methods for Concurrent File Restore and Virus Scanning

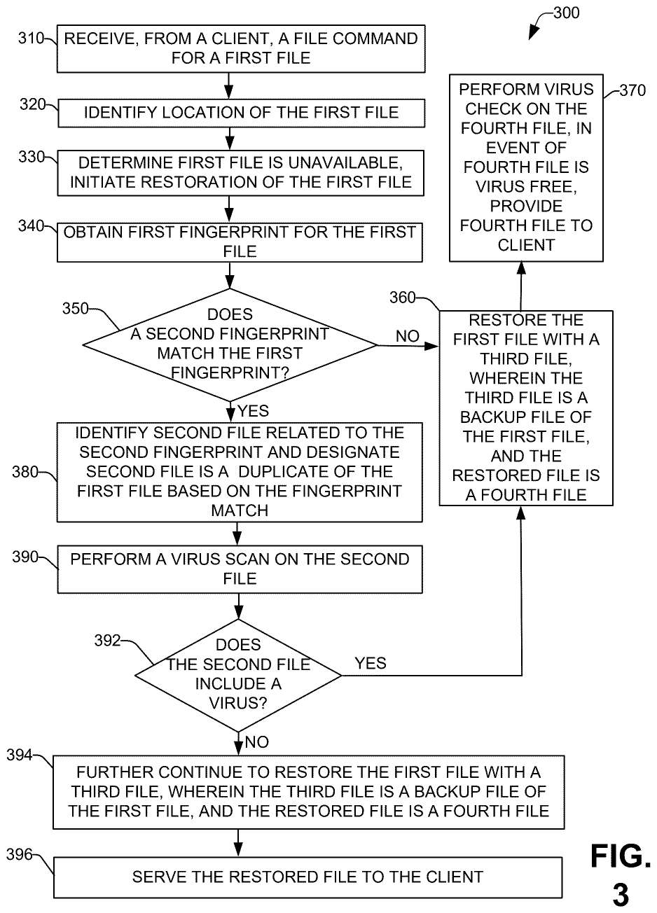

FIG. 3, via flowchart 300, presents an example computer-implemented method for automated concurrent restoration of a file and virus scanning to confirm the restored file does not contain a virus, in accordance with one or more embodiments.

At 310, a file command (e.g., in a communication 197A) can be received (e.g., by file operation component 112) regarding a file (e.g., file 107A). The file can be located on a node (e.g., node 106A) located in data server (e.g., a distributed system, a node cluster system 105). In accordance with an embodiment, the file command can be a read/open request for the file.

At 320, the location of the file on the data server can be determined (e.g., by file operation component 112). For example, the requested file (e.g., file 107A) is located on a first node (e.g., node 106A).

At 330, the requested file is identified (e.g., by file operation component 112) as being currently unavailable. A file restoration process for the request file can be initiated (e.g., file operation component 112 initiating operation of the restore component 114, and also the virus component 116, in accordance with an operation policy 125A).

At 340, concurrent with the file restoration process (per step 360 or step 394), a first fingerprint (e.g., fingerprint 152A) is generated/obtained (e.g., by virus component 116) for the first file.

At 350, the first fingerprint can be compared (e.g., by the virus component 116) with one or more fingerprints (e.g., fingerprints 152B-n) located in a lookup table (e.g., fingerprint table 150). A determination (e.g., by the virus component 116) can be made regarding whether the first fingerprint matches a second fingerprint (e.g., second fingerprint 152B generated from a second file 107B). In response to determining NO, the first fingerprint does not match any of the other fingerprints, process 300 can proceed to step 360, whereupon restoration of the first file can proceed in accordance with a conventional file restore and subsequent virus scan operation (e.g., as previously described). At 360, the first file can be restored with a third, backup file (e.g., file 108A) previously generated for the first file. The restored file (e.g., a fourth file 109A) can be considered to be a restored version of the first file (e.g., file 107A). Process 300 can further advance to step 370, whereupon a virus check can be subsequently performed on the restored file.

At 350, in response to a determination (e.g., by the virus component 116) that the first fingerprint matches with the second fingerprint, process 300 can advance to step 380. At step 380, a second file (e.g., file 107B) corresponding to the second fingerprint can be identified (e.g., by the virus component 116), and further, the second file can be designated (e.g., by the virus component 116) as being a duplicate of the first file.

At 390, a virus scan can be performed (e.g., by the virus component 116) on the second/duplicate file. Content of the second file can be compared with known viruses (e.g., viruses 155A-n).

At 392, in response to a determination (e.g., by the virus component 116) that YES, the second file includes content matching a software virus, process 300 can advance to step 360, as previously described.

At 392, in response to a determination (e.g., by the virus component 116) that NO, the second file does not include content matching a software virus, process 300 can advance to step 394.

At 394, similar to step 360, restoration of the first file can proceed, but rather than proceeding with a conventional file restore, restoration of the first file proceeds while the virus check process is performed. At 394, the first file can be restored with a third, backup file (e.g., file 108A) previously generated for the first file. The restored file (e.g., a fourth file 109A) can be considered to be a restored version of the first file (e.g., file 107A).

At 396, the restored file is served to the client. Hence, the restored file is not provided to the client until after the virus scan of the duplicate file is performed concurrent with the restoration of the first file.

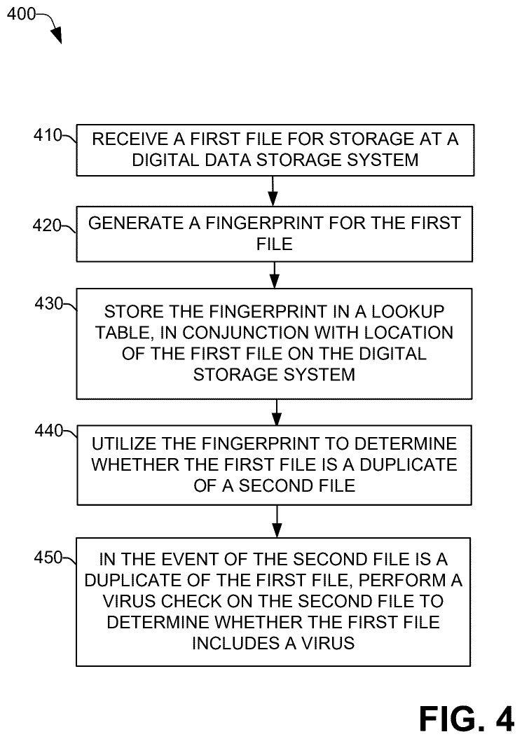

FIG. 4, via flowchart 400, presents an example computer-implemented method for automatically generating and storing fingerprints of a file to determine presence of a duplicate file, in accordance with one or more embodiments.

At 410, a first file can be received (e.g., by file operation component 112) for storage at a data storage system (e.g., a distributed file system, such as a node cluster system 105). In an embodiment, the first file can be stored on a node (e.g., node 106A) of the data storage system.

At 420, a first fingerprint (e.g., a first fingerprint 152A) of the first file can be created (e.g., by virus component 116). Any suitable technology can be utilized, e.g., a hash process (e.g., process 159).

At 430, the first fingerprint can be stored (e.g., by virus component 116) in a lookup table (e.g., fingerprint table 150), in conjunction with a location (e.g., node 106A) of the first file.

At 440, the first fingerprint can be utilized to determine whether a second file exists, whereby the second file has a second fingerprint (e.g., as generated by process 159 from second file 107B). In the event of the first fingerprint and the second fingerprint match (e.g., as determined by the virus component 116), the second file can be considered to be a duplicate of the first file.

At 450, in the event of a second, duplicate file, is identified, a virus scan can be performed on the second file to determine whether the first file comprises a virus while the first file is being restored.

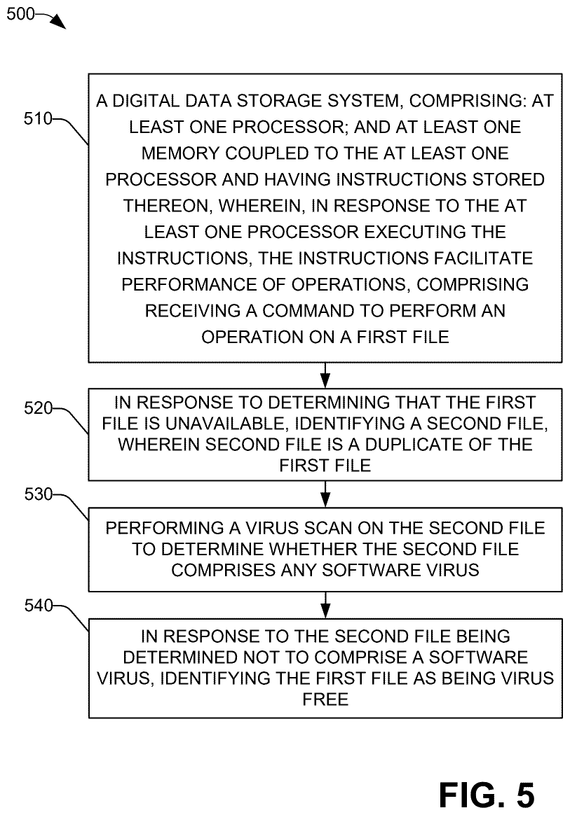

FIG. 5, via flowchart 500, presents an example computer-implemented method for automatic virus scanning during a file restore process, in accordance with one or more embodiments. At 510, the process 500 can comprise a digital data storage system (e.g., distributed file system 105), comprising at least one processor (e.g., processor 182A), and at least one memory (e.g., memory 184A) coupled to the at least one processor and having instructions stored thereon, wherein, in response to the at least one processor executing the instructions, the instructions facilitate performance of operations, comprising receiving (e.g., by file operation component 112) a command (e.g., a file read/open command in communication 197A) to perform an operation on a first file (e.g., file 107A). At 520, process 500 can further comprise, in response to determining (e.g., by file operation component 112) that the first file is unavailable, identifying a second file (e.g., file 107B), wherein second file is a duplicate of the first file. At 530, process 500 can further comprise performing a virus scan (e.g., by virus component 116) on the second file to determine whether the second file comprises any software virus (e.g., a software virus 155A-n). At 540, process 500 can further comprise, in response to the second file being determined (e.g., by virus component 116) not to comprise a software virus, identifying (e.g., by the virus component 116) the first file as being virus free.

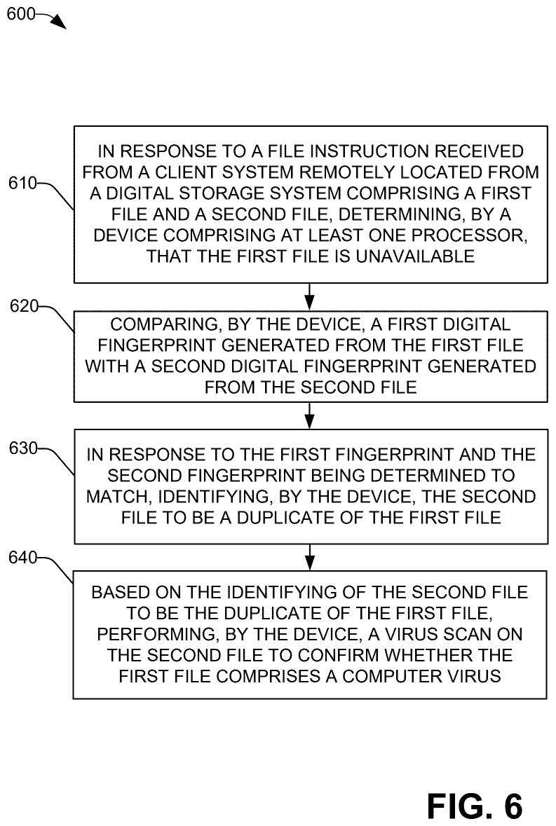

FIG. 6, via flowchart 600, presents an example computer-implemented method for automatic virus scanning during a file restore process, in accordance with one or more embodiments. At 610, process 600 can comprise, in response to a file instruction (e.g., a file read/open command in communication 197A) received from a client system (e.g., client system 130) remotely located from a digital storage system (e.g., distributed file system 105) comprising a first file (e.g., file 107A) and a second file (e.g., file 107B), determining, by a device (e.g., RCS 110) comprising at least one processor (e.g., processor 182A), that the first file is unavailable. At 620, process 600 can further comprise comparing, by the device, a first digital fingerprint (e.g., fingerprint 152A) generated from the first file with a second digital fingerprint (e.g., fingerprint 152B) generated from the second file. At 630, process 600 can further comprise, in response to the first fingerprint and the second fingerprint being determined (e.g., by virus component 116) to match, identifying, by the device, the second file to be a duplicate of the first file. At 640, process 600 can further comprise, based on the identifying of the second file to be the duplicate of the first file, performing, by the device, a virus scan on the second file to confirm whether the first file comprises a computer virus (e.g., computer virus 155A-n).

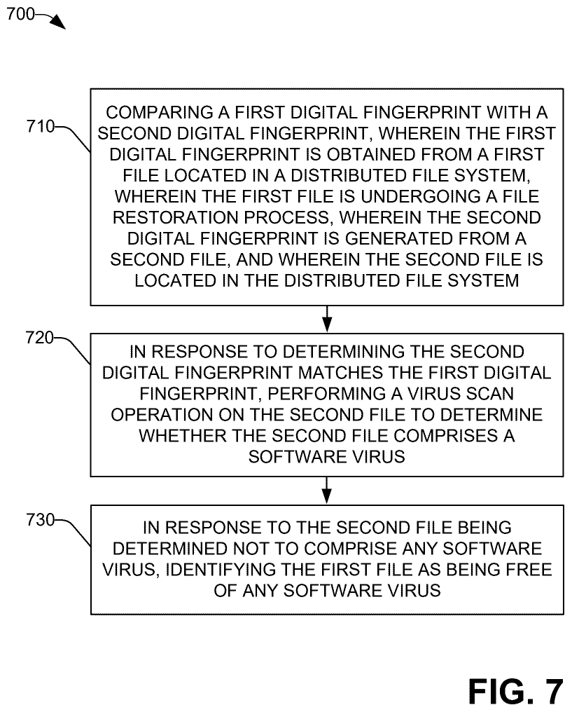

FIG. 7, via flowchart 700, presents an example computer-implemented method for automatic virus scanning during a file restore process, in accordance with one or more embodiments. At 710, the process 700 can be performed by a computer program product stored on a non-transitory computer-readable medium (e.g., memory 184A) and comprising machine-executable instructions, wherein, in response to being executed (e.g., by processor 182A), the machine-executable instructions cause a system (e.g., RCS 110) to perform operations, comprising comparing a first digital fingerprint (e.g., fingerprint 152A) with a second digital fingerprint (e.g., fingerprint 152B), wherein the first digital fingerprint is obtained from a first file (e.g., file 107A) located in a distributed file system (e.g., distributed file system 105), wherein the first file is undergoing a file restoration process (e.g., performed by restore component 114), wherein the second digital fingerprint is generated from a second file (e.g., file 107B), and wherein the second file is located in the distributed file system. At 720, the instructions can further comprise, in response to determining (e.g., by virus component 116) the second digital fingerprint matches the first digital fingerprint, performing (e.g., by virus component 116) a virus scan operation on the second file to determine whether the second file comprises a software virus (e.g., for virus' 155A-n). At 730, the instructions can further comprise, in response to the second file being determined (e.g., by virus component 116) not to comprise any software virus, identifying (e.g., by the virus component 116) the first file as being free of any software virus.

### 4. Example Environments of Use

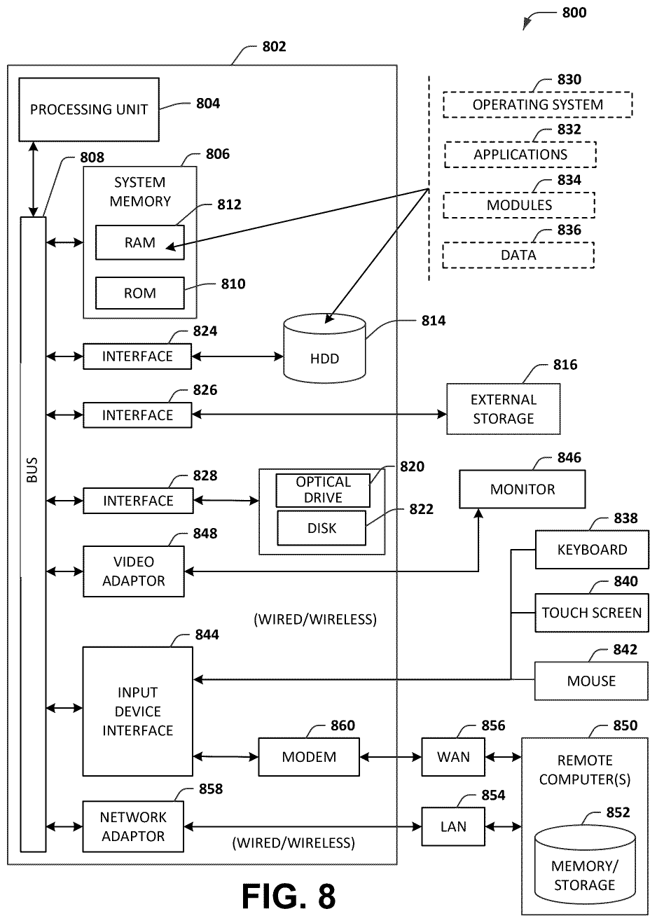

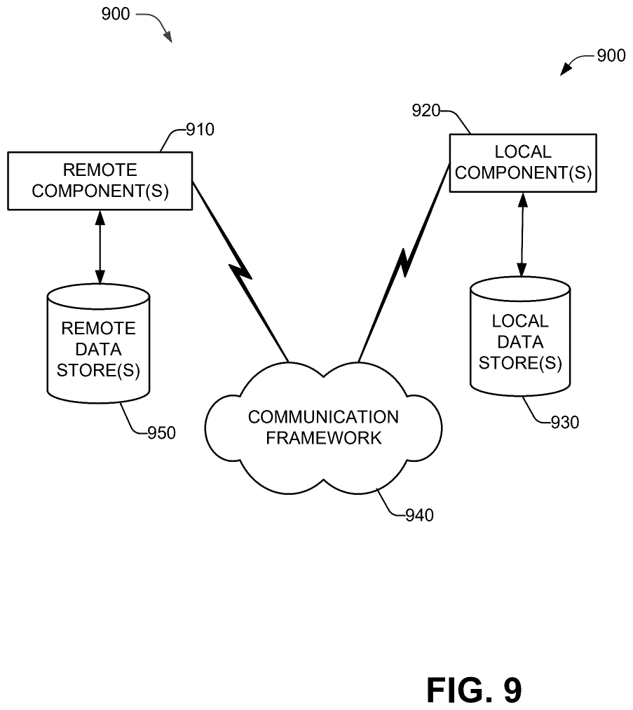

Turning next to FIGS. 8 and 9, a detailed description is provided of additional context for the one or more embodiments described herein with FIGS. 1A-7.

In order to provide additional context for various embodiments described herein, FIG. 8 and the following discussion are intended to provide a brief, general description of a suitable computing environment 800 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 8, the example environment 800 for implementing various embodiments of the aspects described herein includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors and may include a cache memory. Dual microprocessors and other multi-processor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 includes ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also include a high-speed RAM such as static RAM for caching data.

The computer 802 further includes an internal hard disk drive (HDD) 814 (e.g., EIDE, SATA), one or more external storage devices 816 (e.g., a magnetic floppy disk drive (FDD) 816, a memory stick or flash drive reader, a memory card reader, etc.) and an optical disk drive 850 (e.g., which can read or write from a CD-ROM disc, a DVD, a BD, etc.). While the internal HDD 814 is illustrated as located within the computer 802, the internal HDD 814 can also be configured for external use in a suitable chassis (not shown). Additionally, while not shown in environment 800, a solid-state drive (SSD) could be used in addition to, or in place of, an HDD 814. The HDD 814, external storage device(s) 816 and optical disk drive 850 can be connected to the system bus 808 by an HDD interface 824, an external storage interface 826 and an optical drive interface 828, respectively. The interface 824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 812, including an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In such an embodiment, operating system 830 can comprise one virtual machine (VM) of multiple VMs hosted at computer 802. Furthermore, operating system 830 can provide runtime environments, such as the Java runtime environment or the .NET framework, for applications 832. Runtime environments are consistent execution environments that allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries and settings for an application.

Further, computer 802 can comprise a security module, such as a trusted processing module (TPM). For instance, with a TPM, boot components hash next in time boot components, and wait for a match of results to secured values, before loading a next boot component. This process can take place at any layer in the code execution stack of computer 802, e.g., applied at the application execution level or at the operating system (OS) kernel level, thereby enabling security at any level of code execution.

A user can enter commands and information into the computer 802 through one or more wired/wireless input devices, e.g., a keyboard 838, a touch screen 840, and a pointing device, such as a mouse 842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 804 through an input device interface 844 that can be coupled to the system bus 808, but can be connected by other interfaces, such as a parallel port, an IEEE 1394 serial port, a game port, a USB port, an IR interface, a BLUETOOTH® interface, etc.

A monitor 846 or other type of display device can also be connected to the system bus 808 via an interface, such as a video adapter 848. In addition to the monitor 846, a computer typically includes other peripheral output devices (not shown), such as speakers, printers, etc.

The computer 802 can operate in a networked environment using logical connections via wired and/or wireless communications to one or more remote computers, such as a remote computer(s) 850. The remote computer(s) 850 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 852 is illustrated. The logical connections depicted include wired/wireless connectivity to a local area network (LAN) 854 and/or larger networks, e.g., a wide area network (WAN) 856. Such LAN and WAN networking environments are commonplace in offices and companies, and facilitate enterprise-wide computer networks, such as intranets, all of which can connect to a global communications network, e.g., the internet.

When used in a LAN networking environment, the computer 802 can be connected to the local network 854 through a wired and/or wireless communication network interface or adapter 858. The adapter 858 can facilitate wired or wireless communication to the LAN 854, which can also include a wireless access point (AP) disposed thereon for communicating with the adapter 858 in a wireless mode.

When used in a WAN networking environment, the computer 802 can include a modem 860 or can be connected to a communications server on the WAN 856 via other means for establishing communications over the WAN 856, such as by way of the internet. The modem 860, which can be internal or external and a wired or wireless device, can be connected to the system bus 808 via the input device interface 844. In a networked environment, program modules depicted relative to the computer 802 or portions thereof, can be stored in the remote memory/storage device 852. It will be appreciated that the network connections shown are examples and other means of establishing a communications link between the computers can be used.

When used in either a LAN or WAN networking environment, the computer 802 can access cloud storage systems or other network-based storage systems in addition to, or in place of, external storage devices 816 as described above. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, with the aid of the adapter 858 and/or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Referring now to details of one or more elements illustrated in FIG. 9, an illustrative cloud computing environment 900 is depicted. FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise an automatic scaling component and/or programs that communicate/use the remote resources 910 and 920, etc., connected to a remotely located distributed computing system via communication framework 940.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “consumer,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A digital data storage system, comprising:
at least one processor; and
at least one memory coupled to the at least one processor and having instructions stored thereon, wherein, in response to the at least one processor executing the instructions, the instructions facilitate performance of operations, comprising:
receiving a command to perform an operation on a first file;
in response to determining that the first file is unavailable, identifying a second file, wherein second file is a duplicate of the first file;
performing a virus scan on the second file to determine whether the second file comprises any software virus; and
in response to the second file being determined not to comprise a software virus, identifying the first file as being virus free.

2. The digital data storage system of claim 1, wherein the first file is distributed across first storage equipment of a distributed file system and the second file is distributed across second storage equipment of the distributed file system.

3. The digital data storage system of claim 1, wherein the operations further comprise:
restoring the first file, resulting in a restored first file; and
in response to the first file being determined to be virus free, serving the restored first file to a client system, wherein the command to perform the operation on the first file is received from the client system.

4. The digital data storage system of claim 3, wherein the operations further comprise restoring the first file with a third file to generate a fourth file, wherein the fourth file is a restored version of the first file.

5. The digital data storage system of claim 4, wherein the third file is a backup file of the first file.

6. The digital data storage system of claim 5, wherein the first file is located at a first data storage system and the third file is located at a second data storage system, and wherein the second data storage is remotely located from the first data storage system.

7. The digital data storage system of claim 6, wherein the first file is located on a first node in the first data storage system, and the second data storage system is a tape backup system.

8. The digital data storage system of claim 1, wherein the operations further comprise:
generating a first fingerprint of the first file;
comparing the first fingerprint with a second fingerprint generated for the second file; and
in response to determining that the first fingerprint matches the second fingerprint, determining that the second file is the duplicate of the first file.

9. The digital data storage system of claim 8, wherein the first fingerprint and the second fingerprint are generated using a hashing process.

10. The digital data storage system of claim 1, wherein the command to perform the operation is a first command to perform a read file operation or a second command to perform an open file operation.

11. A computer-implemented method, comprising:
in response to a file instruction received from a client system remotely located from a digital storage system comprising a first file and a second file, determining, by a device comprising at least one processor, that the first file is unavailable;
comparing, by the device, a first digital fingerprint generated from the first file with a second digital fingerprint generated from the second file;
in response to the first fingerprint and the second fingerprint being determined to match, identifying, by the device, the second file to be a duplicate of the first file; and
based on the identifying of the second file to be the duplicate of the first file, performing, by the device, a virus scan on the second file to confirm whether the first file comprises a computer virus.

12. The computer-implemented method of claim 11, wherein the file instruction comprises one of a first instruction to perform a read file operation for the first file or a second instruction to perform an open file operation for the first file.

13. The computer-implemented method of claim 11, further comprising:
restoring, by the device, the first file to generate a restored version of the first file; and
in response to a result of the performing of the virus scan indicating that the second file does not comprise any computer virus, executing, by the device, the file instruction on the restored version of the first file.

14. The computer-implemented method of claim 13, wherein the first file is restored with a third file, wherein the third file is a backup copy of the first file, and wherein the third file is located on a backup data server remotely located from the digital storage system.

15. The computer-implemented method of claim 11, wherein the digital storage system is a network attached storage system.

16. The computer-implemented method of claim 11, wherein the digital storage system is a distributed file system comprising a cluster of two or more data storage nodes, wherein the first file is located on a first data storage node in the distributed file system and the second file is located on a second data storage node in the distributed file system, and wherein the first data storage node and the second data storage node are disparate.

17. A computer program product stored on a non-transitory computer-readable medium and comprising machine-executable instructions, wherein, in response to being executed, the machine-executable instructions cause a system to perform operations, comprising:
comparing a first digital fingerprint with a second digital fingerprint, wherein the first digital fingerprint is obtained from a first file located in a distributed file system, wherein the first file is undergoing a file restoration process, wherein the second digital fingerprint is generated from a second file, and wherein the second file is located in the distributed file system;
in response to determining the second digital fingerprint matches the first digital fingerprint, performing a virus scan operation on the second file to determine whether the second file comprises a software virus; and
in response to the second file being determined not to comprise any software virus, identifying the first file as being free of any software virus.

18. The computer program product according to claim 17, wherein the first file is identified in a file operation command received at the distributed file system, wherein the file operation command is one of a read file operation command for the first file or an open file operation command for the first file, and wherein the file operation command is received from a client system remotely located from the distributed file system.

19. The computer program product according to claim 17, wherein the first digital fingerprint and the second digital fingerprint are generated by a common hashing process.

20. The computer program product according to claim 17, wherein the operations further comprise:
restoring the first file to create a third file, wherein the third file is a restored version of the first file, and wherein the third file is generated using a network data management protocol restoration process; and
in response to identifying the first file as being free of any software virus, enabling the third file to be accessible to a client system, wherein the client system is remotely located from the distributed file system.
